(19) United States
(12) Patent Application Publication
(10) Pub. No.: US 2011/0019225 A1
(43) Pub. Date: Jan. 27, 2011

(54) Image forming apparatus and method of controlling low power thereof

(75) Inventor: Ji-won Jung, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/662,045

(22) Filed: Mar. 29, 2010

(30) Foreign Application Priority Data
Jul. 24, 2009 (KR) 2009-0067626

(51) Int. Cl. G06F 1/32; G06F 15/00

(52) U.S. Cl. 358/1.15; 713/323

(57) ABSTRACT

An image forming apparatus and a method of controlling low power thereof are provided. A main power supply unit of the image forming apparatus including a plurality of operation units supplies power and a main controller controls the plurality of operations units in an active mode in which power is supplied to the main controller and the operation units. The main controller enters a standby mode by interrupting power supplied to the main controller and the operation units from the main power supply unit, and data received through at least one communication interface is analyzed to determine whether to convert the standby mode into the active mode.

### CROSS-REFERENCE TO RELATED APPLICATIONS

This application claims the benefit of Korean Patent Application No. 10-2009-67626, filed on Jul. 24, 2009, in the Korean Intellectual Property Office, the disclosure of which is incorporated herein by reference.

### BACKGROUND

1. Field

Aspects of the present embodiments relate to an image forming apparatus and a method of controlling low power thereof, and more particularly, to an image forming apparatus which can minimize power consumption in a standby mode and a method of controlling low power thereof.

2. Description of the Related Art

An operating mode relating to power consumption of an image forming apparatus is divided into an active mode to perform printing, scanning, or copying and a standby mode in which the aforementioned operations are not performed and the apparatus waits for a command. In the active mode, the image forming apparatus performs a normal function as its power switch is turned on, and, in the standby mode, the power switch of the image forming apparatus is turned off, but a main power source is still supplied with power.

The electronic goods including the image forming apparatus spend most of the time in the standby mode rather than in the active mode. Therefore, the energy saving depends on the reduction in energy consumption in the standby mode.

However, even after a related-art image forming apparatus enters a standby mode, the image forming apparatus cannot completely turn off the power of peripherals including a main controller when a wakeup request is input. Therefore, standby power cannot be minimized in the standby mode.

### SUMMARY

Aspects of the present embodiments provide an image forming apparatus which can minimize power consumption in a standby mode and a method of controlling low power thereof.

Additional aspects and/or advantages of the invention will be set forth in part in the description which follows and, in part, will be obvious from the description, or may be learned by practice of the invention.

The foregoing and/or other aspects are achieved by providing an image forming apparatus to control low power, including: a plurality of operation units; a main controller to control the plurality of operation units in an active mode in which power is supplied; a main power supply unit to supply the power to the main controller and the operation units in the active mode; at least one communication interface receiving data; and a sub-controller interrupting power supplied to the main controller and the operation units from the main power supply unit so that the main controller enters a standby mode, and analyzing data received by the at least one communication interface and determining whether to convert the standby mode into the active mode.

The sub-controller may include: a first media access controller (MAC) receiving data input through the at least one communication interface; a processor analyzing data received through the first MAC and controlling the main power supply unit to supply the power to the main controller when it is determined to convert the standby mode into the active mode; and a second MAC relaying the data which is received by the first MAC to the main controller when the standby mode is converted into the active mode.

The sub-controller may further include a switch to control a transmitting time of the data when the second MAC transmits the data in the format of media independent interface (MII), gigabit MII (GMI), and reduced GMII (RGMII).

The sub-controller may include: a universal serial bus (USB) device receiving data through the at least one communication interface; and a USB host relaying the data received by the USB device to the main controller when the standby mode is converted into the active mode, a processor analyzing the data received through the USB device to determine whether to convert the standby mode into the active mode.

The sub-controller may include: a media access controller (MAC) receiving data through one of the at least one communication interface; a processor analyzing the received data and controlling the main power supply unit to supply the power to the main controller when it is necessary to convert the standby mode into the active mode; and a universal serial bus (USB) host relaying the data received through the MAC to the main controller when the standby mode is converted into the active mode.

The sub-controller may further include a USB device receiving data through another of the at least one communication interface, the processor analyzing the data received by the USB device to determine whether to convert the standby mode into the active mode, the USB host relaying the data received through the USB device to the main controller when the standby mode is converted into the active mode.

The sub-controller may include: a universal serial bus (USB) device receiving data through one of the at least one communication interface; a processor analyzing the received data, determining whether to convert the standby mode into the active mode, and controlling the main power supply unit to supply the power to the main controller when it is determined to convert the standby mode into the active mode; and a data output media access controller (MAC) relaying the data received through the USB device to the main controller when the standby mode is converted into the active mode.

The sub-controller may further include a data input MAC receiving data through another of the at least one communication interface, the processor analyzing the data received through the data input MAC to determine whether to convert the standby mode into the active mode, the data output MAC relaying the data received through the data input MAC to the main controller when the standby mode is converted into the active mode.

The main controller may convert a mode of a memory communicating with the main controller into a self-refresh mode, and the sub-controller may interrupt power supplied to the main controller and the operation units from the main power supply unit and maintain power supplied to the sub-controller when the mode of the memory is converted into the self-refresh mode.

The image forming apparatus may further include a low power supply unit supplying power to the sub-controller.

The at least one communication interface may be at least one of a network interface and a universal serial bus (USB) interface.

The sub-controller may be connected to a fax transceiver to transceive data with an external facsimile machine or a wakeup button to request conversion from the standby mode to the active mode, and may analyze data input from the fax transceiver or the wakeup button to determine whether to convert the standby mode into the active mode.

The sub-controller may convert the standby mode into the active mode and the fax transceiver may relay fax data received from the external facsimile machine to the main controller when a ring signal is detected from the fax transceiver.

Each of the plurality of operation units may include an image forming mechanism to output the fax data on paper.

The foregoing and/or other aspects are achieved by providing a method of controlling low power by an image forming apparatus which includes a main power supply unit, a main controller, a sub-controller, and a plurality of operation units, the method including: supplying power to the main controller that controls the operation units and the operation units in an active mode, from the main power supply unit; entering a standby mode by interrupting power supplied to the main controller and the operation units from the main power supply unit, by the sub-controller; and determining whether to convert the standby mode into the active mode by analyzing data received through at least one communication interface connected to the sub-controller.

The data received through the at least one communication interface may be received by a first media access controller (MAC), and the method may further include supplying the power to the main controller and converting the standby mode into the active mode when it is determined to convert the standby mode into the active mode as a result of analyzing the data received through the first MAC; and relaying the data received through the first MAC to the main controller through a second MAC.

The relaying may further include relaying the data by controlling a transmitting time of the data using a switch when the second MAC transmits the data in the format of media independent interface (MII), gigabit MII (GMI), and reduced GMII (RGMII).

The determining may include receiving the data input from one of the at least one communication interface, by a universal serial bus (USB) device, and the method may further include relaying the data received through the USB device to the main controller, by a USB host when the standby mode is converted into the active mode.

The determining may include receiving the data input from one of the at least one communication interface, by a media access controller (MAC), and the method may further include: supplying the power to the main controller and converting the standby mode into the active mode when a determination is made to convert the standby mode into the active mode as a result of analyzing the data received through the MAC; and relaying the data received through the MAC to the main controller by a universal serial bus (USB) host.

The determining may include receiving the data input from another of the at least one communication interface, by a USB device, and the USB host may relay the data received through the USB device to the main controller when the standby mode is converted into the active mode.

The determining may include receiving the data input from one of the at least one communication interface, by a universal serial bus (USB) device, and the method may further include: supplying the power to the main controller by the main power supply unit and converting the standby mode into the active mode when a determination is made to convert the standby mode into the active mode as a result of analyzing the data received through the USB device; and relaying the data received through the USB device to the main controller through a data output media access controller.

The determining may include receiving the data input through another of the at least one communication interface, by a data input media access controller (MAC), and the data output MAC may relay the data received by the data input MAC to the main controller when the standby mode is converted into the active mode.

The entering the standby mode may include: changing a mode of a memory communicating with the main controller to a self-refresh mode; interrupting power supplied to the main controller and the operation units from the main power supply unit under control of the sub-controller; and maintaining power supplied to the sub-controller.

The at least one communication interface may be at least one of a network interface and a universal serial bus (USB) interface.

The sub-controller may be further connected to a fax transceiver to transceive data with an external facsimile machine or a wakeup button to request conversion from the standby mode to the active mode, and may analyze data input from the fax transceiver or the wakeup button to determine whether to convert the standby mode into the active mode.

The foregoing and/or other aspects are achieved by providing an image forming apparatus, including: a plurality of peripheral operation units; a main controller controlling the peripheral operation units in an active mode in which power is supplied; a main power supply unit supplying power to the main controller and the peripheral operation units in the active mode; at least one communication interface receiving data from an external source; and a sub-controller in communication with the main power supply unit, the at least one communication interface and the main controller, the sub-controller controlling the main power supply unit and supplying the data received by the at least one communication interface to the main controller, wherein, when the main controller is in a standby mode, the sub-controller converts the standby mode into the active mode so the main power supply unit supplies power to the main controller and the peripheral operation units when the data received through the at least one communication interface is determined to be processed under the control of the main controller.

The data received by the at least one communication interface may be indirectly input to the main controller through the sub-controller.

The data from the external source may not be directly input to the main controller.

The foregoing and/or other aspects are achieved by providing an image forming apparatus, including: a plurality of peripheral operation units; a main controller controlling the peripheral operation units in an active mode in which power is supplied; a main power supply unit supplying power to the main controller and the peripheral operation units in the active mode; at least one communication interface receiving data from an external source; and a sub-controller receiving data from the at least one communication interface and converting a standby mode of the main controller into the active mode by outputting a supply control signal to the main power supply unit to allow the main power supply unit to supply power to the main controller and the peripheral operation units after power supplied to the main controller and peripheral operation units is interrupted in the standby mode, based on the data received from the at least one communication interface.

The foregoing and/or other aspects are achieved by providing a method of controlling an image forming apparatus which includes a main power supply unit, a main controller, a sub-controller, a plurality of operation units and at least one communication interface, the method including: receiving data from an external source at the at least one communication interface; transmitting the data from the at least one communication interface to the sub-controller; and converting, when the main controller is in a standby mode in which power is not supplied from the main power supply unit to the main controller and the operation units, the standby mode of the main controller into an active mode by outputting a supply control signal to the main power supply unit to allow the main power supply unit to supply power to the main controller and the peripheral operation units, based on the data received by the sub-controller from the at least one communication interface.

According to the present embodiments, in the standby mode, the power supplied to the main controller is completely interrupted and the power supplied to the sub-controller is maintained so that minimum power lower than 1 W can be consumed.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating an image forming apparatus to control low power according to at least one embodiment;

FIG. 2 is a flowchart illustrating a method of controlling low power of the image forming apparatus of FIG. 1;

FIGS. 3 to 6 are block diagrams each illustrating an image forming apparatus to control low power according to at least one embodiment;

FIG. 7 is a flowchart illustrating a process of converting an active mode into a standby mode in a method of controlling low power of the image forming apparatus of FIG. 3;

FIG. 8 is a flowchart illustrating a process of converting a standby mode into an active mode in the method of controlling low power of the image forming apparatus of FIG. 3; and

FIG. 9 is a block diagram illustrating an image forming apparatus to control low power according to at least one embodiment.

### DETAILED DESCRIPTION

Reference will now be made in detail to the present embodiments, examples of which are illustrated in the accompanying drawings, wherein like reference numerals refer to the like elements throughout. The embodiments are described below in order to explain the present invention by referring to the figures.

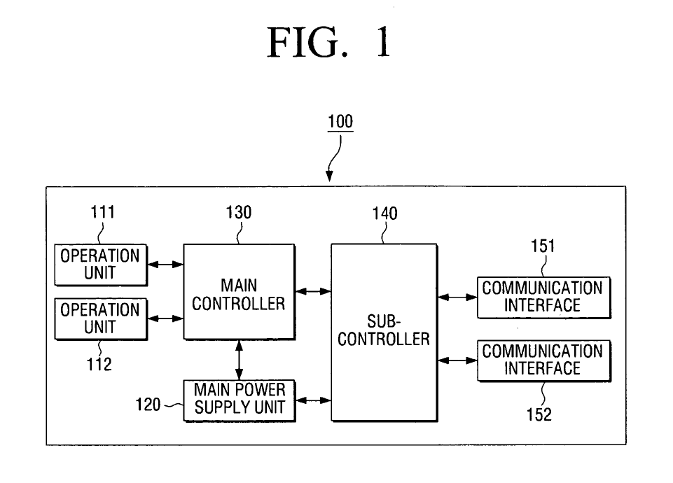

FIG. 1 is a block diagram illustrating an image forming apparatus 100 to control low power according to an exemplary embodiment. Referring to FIG. 1, the image forming apparatus 100 includes a plurality of operation units 111, 112, a main power supply unit 120, a main controller 130, a sub-controller 140, and a plurality of communication interfaces 151, 152. The image forming apparatus 100 is operated by power supplied from the main power supply unit 120 and can minimize power consumption in a standby mode of power saving by interrupting power supplied to the operation units 111, 112 and completely turning off the main power supply unit 120.

An active mode refers to a mode in which the image forming apparatus 100 is performing its particular function or is currently able to perform its particular function when a request to do so is input, and a standby mode refers to a mode in which the image forming apparatus 100 is not performing its particular function and is waiting for a request. In this embodiment, the image forming apparatus 100 consumes only low power, which is less than 1 W in the standby mode, for example.

The image forming apparatus 100 refers to an apparatus that performs generating, printing, receiving, and transmitting image data and may include a printer, a scanner, a photocopier, a facsimile machine and a multifunction peripheral, for example. The method for low power consumption provided by the image forming apparatus 100 can be applied to all electronic goods, including a television, a computer, and a laptop computer, for example.

The plurality of operation units 111, 112 may be one of a printing unit, a copying unit, a scanning unit, an auto document feeder (ADF) unit, a finisher unit, a high capacity feeder (HCF) unit, and a double capacity feeder (DCF) unit, for example.

The main power supply unit 120 supplies power to the plurality of operation units 111, 112, the main controller 130, the sub-controller 140 and the plurality of communication interface units 151, 152 when the image forming apparatus 100 is in the active mode, and interrupts the power supplied to the plurality of operation units 111, 112 and the main controller 130 in the standby mode.

In the active mode in which power is supplied, the main controller 130 controls the plurality of operation units 111, 112 to perform their respective functions, and processes data which is relayed through the plurality of communication interfaces 151, 152 and the sub-controller 140 according to the characteristics of the data. For example, if the data input through the communication interface 151 and the sub-controller 140 is data to be printed, the main controller 130 transmits the data to a printing operation unit to print the data.

The sub-controller 140 interrupts the power supplied to the main controller 130 and the plurality of operation units 111, 112 from the main power supply unit 120 to allow the main controller 130 to enter the standby mode, and analyzes the data which is received through at least one communication interface 151, 152 to determine whether to convert the standby mode into the active mode.

For example, if the plurality of operation units 111, 112 is in an idle state for a predetermined time, the main controller 130 determines that the image forming apparatus 100 should enter the standby mode and notifies the sub-controller 140 of such. The sub-controller 140 performs the above operation according to the notification from the main controller 130. Also, if the data received through the communication interfaces 151, 152 should be processed under the control of the main controller 130, the sub-controller 140 converts the standby mode into the active mode and controls the main power supply unit 120 to supply power to the main controller 130 and the plurality of operation units 111, 112.

Since the plurality of communication interfaces 151, 152 is communicably connected to the sub-controller 140, the data is not directly input to the main controller 130 from an external source, but is input to the main controller 130 via the sub-controller 140. This is to convert the standby mode and the active mode more effectively and thus minimize power consumption.

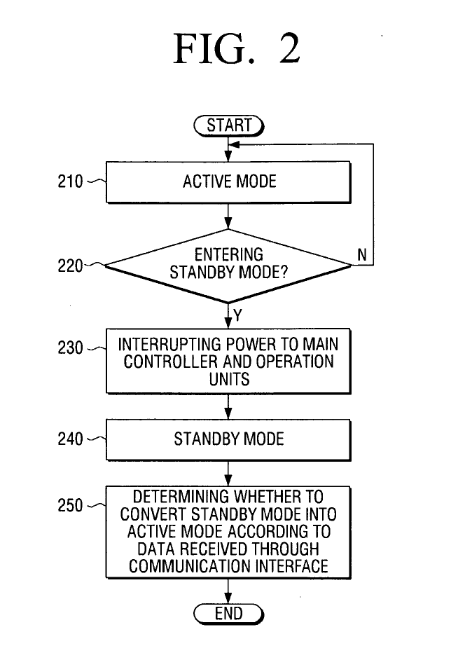

FIG. 2 is a flowchart illustrating a method of controlling low power of the image forming apparatus of FIG. 1.

Referring to FIG. 2, in the active mode in which the image forming apparatus 100 is normally operated (210), if it is determined that it is necessary to enter the standby mode (220), the main controller 130 notifies the sub-controller 140 of this necessity.

According to the notification from the main controller 130, the sub-controller 140 controls the main power supply unit 120 to interrupt the power supplied to the main controller 130 and the plurality of operation units 111, 112 (230).

Accordingly, the mode of the image forming apparatus 100 converts into the standby mode (240).

After that, the sub-controller 140 determines whether to convert the standby mode into the active mode according to the data received through one of the plurality of communication interfaces 151, 152 (250).

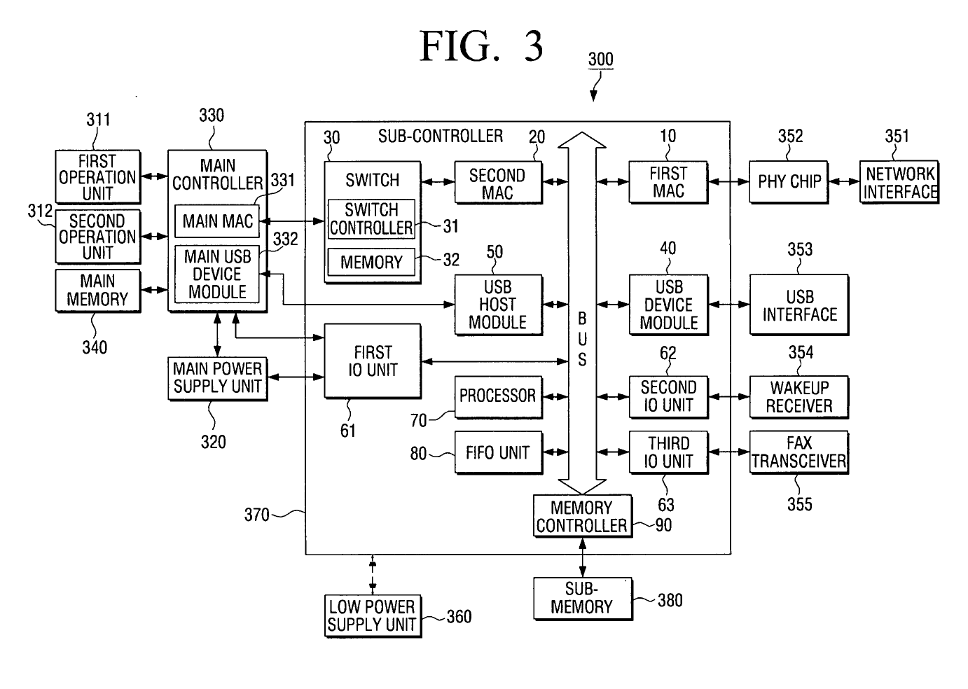

FIG. 3 is a block diagram illustrating an image forming apparatus of controlling low power according to another exemplary embodiment.

Referring to FIG. 3, an image forming apparatus 300 includes a first operation unit 311 and a second operation unit 312, a main power supply unit 320, a main controller 330, a main memory 340, a network interface 351, a PHY chip 352, a universal serial bus (USB) interface 353, a wakeup receiver 354, a fax transceiver 355, a low power supply unit 360, a sub-controller 370, and a sub-memory 380. The respective components of FIG. 3 are communicably connected to one another via a BUS, and the main power supply unit 320 may be connected to the components to supply power to them, but the connection is not illustrated.

Since the first and the second operations units 311, 312, the main power supply unit 320, the main controller 330, and the sub-controller 370 are almost the same as the plurality of operation units 111, 112, the main power supply unit 120, the main controller 130 and the sub-controller 140 of FIG. 1, the detailed description thereof is omitted.

Two or more of the first and the second operations units 311, 312 may be provided but only the two operations units are illustrated for the sake of simplicity.

In an active mode, the main power supply unit 320 supplies power to the respective components of the image forming apparatus 300. In a standby mode, if the low power supply unit 360, which supplies power to the sub-controller 370, is not separately provided, the main power supply unit 320 interrupts the power supplied to the first and the second operation units 311, 312, the main controller 330, and the main memory 340, but maintains the power supplied to the network interface 351, the PHY chip 352, the USB interface 353, the wakeup receiver 354, the fax transceiver 355, the sub-controller 370, and the sub-memory 380. The main power supply unit 320 supplies power through a first input and output (10) unit 61.

Also, in the standby mode, if the low power supply unit 360 is provided, the main power supply unit 320 interrupts the power supplied to the first and the second operation units 311, 312, the main controller 330, the main memory 340, the network interface 351, the PHY chip 352, the USB interface 353, the wakeup receiver 354, the fax transceiver 355, the sub-controller 370, and the sub-memory 380. At this time, the low power supply unit 360 supplies the power to the sub-controller 370 and the sub-memory 380.

Hereinafter, the image forming apparatus in the active mode prior to entering the standby mode will be described.

In the active mode in which power is supplied, the main controller 330 controls the first and the second operation units 311, 312 and maintains the active mode. If the image forming apparatus 300 is not operated for a predetermined time, the main controller 330 determines that the image forming apparatus enters the standby mode and notifies the sub-controller 370 of such.

The main controller 330 includes a main media access controller (MAC) 331 and a main USB device module 332. The main MAC 331 data-communicates with a first MAC 10 and a second MAC 20 through a switch 30 of the sub-controller 370. The main USB device module 332 data-communicates with a USB host module 50 of the sub-controller 370.

When the image forming apparatus 300 is powered-on and booted, the main memory 340 loads and stores the programs necessary to drive the image forming apparatus 300 and the status information of the image forming apparatus 300 from a read-only memory (ROM) (not shown). The main memory 340 may be a random access memory (RAM), for example, a DDR memory, but not limited thereto.

The network interface 351 serves as a communication interface and provides a network connector to communicate with an external network. For example, a network interface card is connected to the network interface 351 so that data transmission and reception over a network is possible and an Internet function can be provided.

The PHY chip 352 outputs the data which is received from the network through the network interface 351 to the first MAC 10 using a protocol corresponding to a physical layer of an open system interconnection (OSI) model.

The USB interface 353 is a connector to which a USB device or a USB cable is connected. For example, various devices, such as a USB memory, a personal computer, and a laptop computer may be connected to the USB interface 353. Data provided from an external source through the USB interface 353 is output to a USB device module 40.

The wakeup receiver 354 serves as a user interface through which a user requests the image forming apparatus to enter the active mode when the image forming apparatus 300 is in the standby mode, and outputs a requested signal to the sub-controller 370 through a second IO unit 62. The wakeup receiver 354 may be realized as a physical button provided on the image forming apparatus 300 or a sensor receiving a signal input from a remote controller (not shown), for example, but is not limited thereto.

The fax transceiver 354 is a circuit which performs fax transceiving and notifies the sub-controller 370 through a third IO unit 63 of ring signal reception when a ring signal has been received from an external facsimile machine (not shown).

The low power supply unit 360 may be optionally provided. The low power supply unit 360 may not provided if the main power supply unit 320 supplies power to the sub-controller 370, the sub-memory 380 and the components 351-355 in the standby mode. However, if the main power supply unit 320 does not supply power to the sub-controller 370 in the standby mode, the low power supply unit 360 is provided to supply power to the sub-controller 370, the sub-memory 380, and the components 351-355. Hereinafter, the case in which the low power supply unit 360 is not provided will be described.

If a request to convert the active mode into the standby mode is input from the main controller 330, the sub-controller 370 interrupts the power supplied to the main controller 330 and the first and the second operation units 311, 312 from the main power supply unit 320 to allow the main controller 330 to enter the standby mode. Also, the sub-controller 370 analyzes the data received from an external source through the network interface 351, the USB interface 353, the wakeup receiver 354, or the fax transceiver 355, which are communicably connected to the sub controller 370, to determine whether to convert the standby mode into the active mode.

To accomplish this, the sub-controller 370 includes the first MAC 10, the second MAC 20, the switch 30, the USB device module 40, the USB host module 50, the first through the third IO units 61, 62, 63, a processor 70, a first in first output (FIFO) unit 80, and a memory controller 90.

The first MAC 10 receives the data from the network interface 351 via the PHY chip 352, and performs a general Ethernet MAC function. The first MAC 10 and the PHY chip 352 may be connected to each other through a media independent interface (MII) for 100 Mbps transmission, a gigabit MII (GMII) for 1 Gbps transmission or a reduced GMII (RGMII), for example. Therefore, the first MAC 10 supports the MII, GMII or RGMII transmission.

The first MAC 10 supports a direct memory access (DMA) function and accordingly outputs the data received through the MII, GMII or RGMII to the FIFO unit 80 or the sub-memory 380 under the control of the sub-controller 370. Hereinafter, the case in which the data is output to the sub-memory 380 and is temporarily stored in the sub-memory 380 will be described for example.

The second MAC 20 reads out the data which is output from the first MAC 10 and stored in the sub-memory 380 and transmits the data to the switch 30. Reading out the data from the sub-memory 380 may be performed by the DMA function supported by the second MAC 20. Hereinafter, the function of relaying the data input through the network interface 351, the USB interface 353, the wakeup receiver 354 and the fax transceiver 355 to the main controller 330 is referred to as “relay”.

The switch 30 relays the data of MII, GMII or RGMII format input from the second MAC 20 to the main MAC 331 of the main controller 330 and simultaneously controls a transmitting time of the data. To accomplish this, the switch 30 includes a switch controller 31 and a memory 32. The switch controller 31 stores the data of the MII, GMII, or RGMII format to the memory 32 and controls the transmitting time to promptly transmit the data to the main controller 330 from the memory 32.

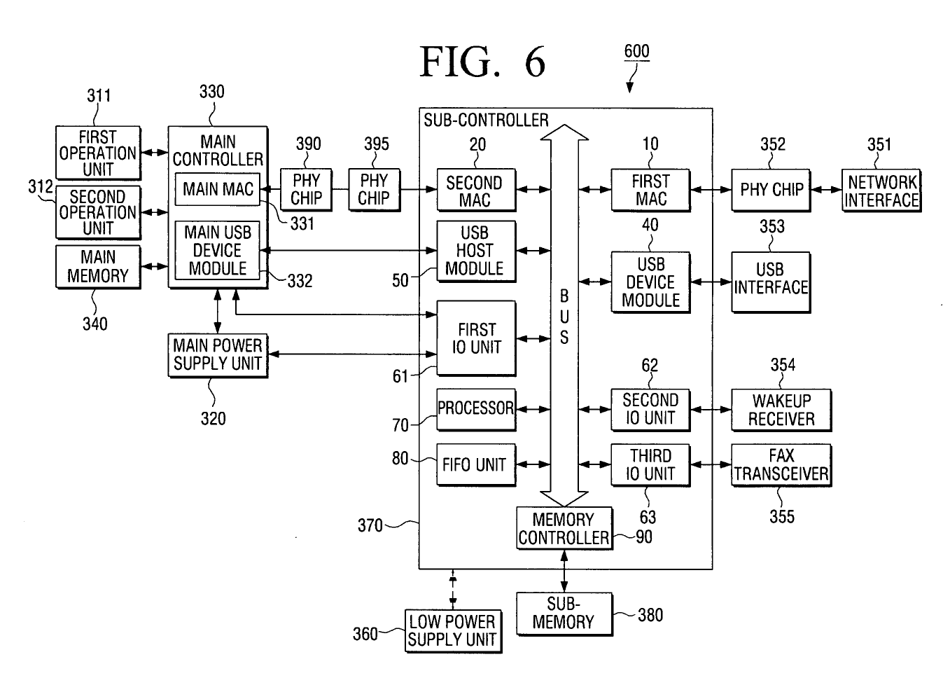

In practice, as shown in FIG. 6, at least two PHY chips are required to transmit the data of the MII, GMII or RGMII format from the main controller 330 to the sub-controller 370, and the switch 30 performs the function provided by the at least two PHY chips. Therefore, increase in the manufacturing cost and power consumption by the addition of the at least two PHY chips can be prevented.

The USB device module 40 receives the data that the USB interface 353 has received from an external source. To accomplish this, the USB device module 40 may include a USB PHY chip (not shown), a USB device (not shown), and a DMA (not shown), and as the respective functions thereof are well known in the related art, the detailed description is thus omitted. However, the data received by the USB interface 353 is received through the USB PHY chip (not shown) and is temporarily stored in the sub-memory 380 through the USB device (not shown) and the DMA (not shown).

The USB host module 50 relays the data which has been received by the USB device module 40 to the main USB device module 332. To accomplish this, the USB host module 50 may includes a DMA (not shown), a USB host (not shown), and a USB PHY chip (not shown), and as the respective functions thereof are well known in the related art, the detailed description is thus omitted. However, the data temporarily stored in the sub-memory 380 is read out by the DMA (not shown) and is relayed to the main controller 330 through the USB host (not shown) and the USB PHY chip (not shown).

The first through the third IO units 61, 62, 63 serve as an input and output interface, an input and output pin or a cable connector and receive power, signals, and data. The first IO unit 61 is connected to the main power supply unit 320 to receive power and is also connected to the main controller 330 to receive various signals or data. The second IO unit 62 is connected to the wakeup receiver 354 to receive a signal requesting conversion from the standby mode into the active mode. The third IO unit 63 is connected to the fax transceiver 355 to receive a ring signal and receive fax data from an external facsimile machine.

In the active mode, the processor 70 analyzes the data which is input from the first MAC 10, the USB device module 40, and the second and the third IO units 62, 63, and relays data to the main controller 330 if the data should be processed under the control of the main controller 330, and processes data by itself if the data can be processed by the sub-controller 370. The processor 70 may be realized as an advanced RISC machine (ARM) core, for example.

Also, the processor 70 outputs an interruption control signal to the main power supply unit 320 if a signal requesting conversion from the active mode into the standby mode is received from the main controller 330 through the first IO unit 61 or another IO unit (not shown). The interruption control signal interrupts the power supplied from the main power supply unit 320 to the main controller 330 and the first and the second operation units 311, 312. Accordingly, the main power supply unit 320 supplies minimum power to the sub-controller 370 and the components 351-355, 360, 380 connected to the sub-controller 370 and does not supply power to the main controller 330 and the components 311, 312, 340 connected to the main controller 330. To this end, the image forming apparatus 300 enters the standby mode from the active mode.

Meanwhile, the main controller 330 may change the mode of the main memory 340 communicating with the main controller 330 to a self-refresh mode and transmit a signal indicating that the mode has changed to the sub-controller 370 through the first IO unit 61, thereby requesting conversion from the active mode into the standby mode. If the signal is received, the processor 70 outputs the interruption control signal to the low power supply unit 360 to enter the standby mode. The self-refresh mode internally generates a refresh request signal and controls signals without receiving a control signal from an external source for the purpose of low power consumption, and executes a refresh operation by an internally generated address.

The FIFO unit 80 or the sub-memory 380 temporarily stores the data which is received through the network interface 351, the USB interface 353, the wake up receiver 354 or the fax transceiver 355.

If the data which is received through the components 351, 353-355 is set to be temporarily stored in the sub-memory 380, the memory controller 90 stores the data to the sub-memory 380, and reads out the data from the sub-memory 380 when the data is relayed and outputs the data to the second MAC 20 or the USB host module 50.

Also, when the image forming apparatus 300 is powered on and booted, the memory controller 90 loads the status information of the image forming apparatus 300 stored in the ROM (not shown), a system program necessary to drive the image forming apparatus 300 in the standby mode, and the wakeup condition, and stores them to the sub-memory 380. The status information of the image forming apparatus 300 may indicate a remaining toner and progress of a job, for example. The sub-controller 370 or the processor 70 partially controls the operation of the image forming apparatus 300 in the active mode and the standby mode using the stored system program.

Hereinafter, a process of converting the standby mode into the active mode will be described.

If the image forming apparatus 300 enters the standby mode, the sub-controller 370 maintains the driving condition with minimum power supplied from the main power supply unit 320 or the low power supply unit 360. If data is received through the components 351, 353-355 in the standby mode, the processor 70 analyzes the received data to determine whether the data satisfies the wakeup condition or can be processed by itself. If the data received through the components 351, 353-355 in the standby mode is determined to be processed by the main controller 330, the data satisfies the wakeup condition. The wakeup condition is satisfied if the received data is a fax ring signal, a selection signal of the wakeup receiver 354, a printing request signal, a cover open detection signal, a tray open detection signal, or an input signal, such as a mouse click signal.

If the received data satisfies the wakeup condition, the processor 70 determines that it is necessary to convert the standby mode into the active mode and controls the first IO unit 61 to output a supply control signal to the main power supply unit 320. The supply control signal refers to a signal that allows the main power supply unit 320 to supply power to the first and the second operation units 311, 312, the main controller 330, and the main memory 340. To this end, the image forming apparatus 300 converts the standby mode into the active mode.

The case in which the data received through the network interface 351 (hereinafter, referred to as “network data”) is relayed in the standby mode will be explained. The network data is input to the first MAC 10 through the network interface 351 and the PHY chip 352.

The processor 70 stores the network data input to the first MAC 10 to the FIFO unit 80 or the sub-memory 380, and analyzes the network data to determine whether the network data satisfies the wakeup condition or not. That is, the processor 70 determines whether it is necessary to convert the standby mode into the active mode. If it is determined that it is necessary to convert the standby mode into the active mode, the processor 70 controls the main power supply unit 320 to supply power to the image forming apparatus 300.

If the standby mode is converted into the active mode, the second MAC 20 reads out the network data from the FIFO unit 80 or the sub-memory 380 and provides the data to the switch 30. The switch 30 transmits the network data to the main MAC 331 of the main controller 330 while synchronizing the network data. The data transmitting path from the main MAC 331 to the network interface 351 is the reverse of the above-described process.

The case in which the data received through the USB interface 353 (hereinafter, referred to as “USB data”) is relayed in the standby mode will be explained. The USB data is input from an external device connected to the USB interface 353 and stored in the FIFO unit 80 or the sub-memory 380 under the control of the processor 70.

The processor 70 analyzes the USB data to determine whether it is necessary to convert the standby mode into the active mode. If it is determined that it is necessary to convert the standby mode into the active mode, the processor 70 controls the main power supply unit 320 to supply power to the image forming apparatus 300. If the standby mode is converted into the active mode, the USB host module 50 reads out the USB data from the FIFO unit 80 or the sub-memory 380 and relays the USB data to the main USB device module 332. The data transmission path from the main USB device module 332 to the USB interface 353 is the reverse of the above-described process.

The case in which the data received through the wakeup receiver 354 (hereinafter, referred to as “wakeup data”) is relayed in the standby mode will be explained. Since the wakeup data refers to a direct signal to request conversion from the standby mode into the active mode, the processor 70 stores the wakeup data to the FIFO unit 80 or the sub-memory 380 and controls the main power supply unit 320 to supply power to the image forming apparatus 300. To this end, the image forming apparatus 300 is converted from the standby mode into the active mode. In the active mode, the processor 70 reads out the wakeup data and relays the wakeup data to the main controller 330 through the first IO unit 61.

The case in which the data received through the fax transceiver 355 (hereinafter, referred to as “fax data”) is relayed in the standby mode will be explained. An external facsimile machine communicably connected to the fax transceiver 355 transmits fax data to the fax transceiver 355. The fax data includes a ring signal and actual data which is to be scanned and printed. The fax transceiver 355 transmits the ring signal to the sub-controller 370 through the second IO unit 62, and, since the ring signal satisfies the wakeup condition, the processor 70 controls the main power supply unit 320 to supply power to the image forming apparatus 300.

If the mode is converted from the standby mode into the active mode, the fax transceiver 355 receives the actual data from the external facsimile machine and the processor 70 stores the actual data in the FIFO unit 80 or the sub-memory 380 and relays the data to the main controller 330 through the third IO unit 63. The main controller 330 controls a corresponding operation unit (for example, 311) to scan and print the relayed actual data.

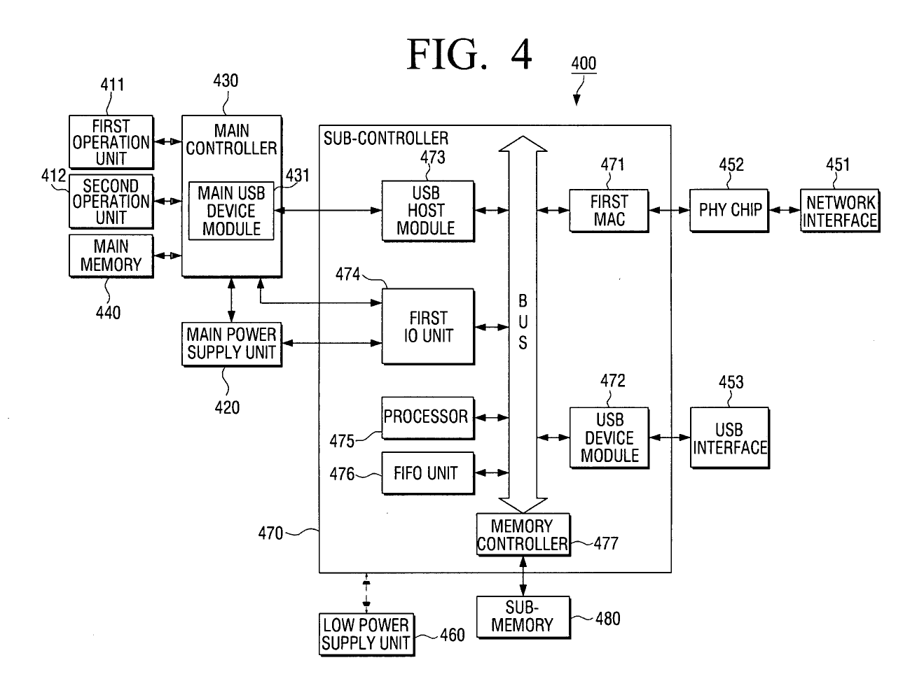

FIG. 4 is an image forming apparatus according to another exemplary embodiment.

Referring to FIG. 4, an image forming apparatus 400 includes a first operation unit 411 and a second operation unit 412, a main power supply unit 420, a main controller 430, a main memory 440, a network interface 451, a PHY chip 452, a USB interface 453, a low power supply unit 460, a sub-controller 470, and a sub-memory 480. Since the respective components of the image forming apparatus 400 are almost the same as those of the image forming apparatus 300 of FIG. 3, the detailed description thereof is omitted. Also, for the sake of simplicity, the wakeup receiver 354, the fax transceiver 355, and the second and the third IO units 62, 63 are not illustrated.

However, in FIG. 4, the main controller 430 does not include a main MAC 331 and the sub-controller 470 does not include a second MAC 20 and a switch 30. Therefore, the network data received through the network interface 451 is relayed to a main USB device module 431 of the main controller 430 via a first MAC 471, a memory controller 477, the sub-memory 480, and a USB host module 473. The relaying process is controlled by the sub-controller 470 or a processor 475.

More specifically, in the standby mode, the network data is temporarily stored to the sub-memory 480 via the network interface 451, the PHY chip 452, the first MAC 471 and the memory controller 477 or temporarily stored to a FIFO unit 476 via the network interface 451, the PHY chip 452 and the first MAC 471. If the network data should be processed under the control of the main controller 430, the processor 475 converts the mode of the image forming apparatus 400 into the active mode. If the mode is converted from the standby mode into the active mode, the USB host module 473 reads out the network data from the FIFO unit 476 or the sub memory 480 and relays the network data to the main USB device module 431.

The USB data received through the USB interface 453 is relayed in the same manner as that described with reference to FIG. 3. For example, data provided from an external source through the USB interface 453 is output to a USB device module 40.

In addition, a first IO unit 474 is connected to the main power supply unit 420 to receive power and is also connected to the main controller 430 to receive various signals or data.

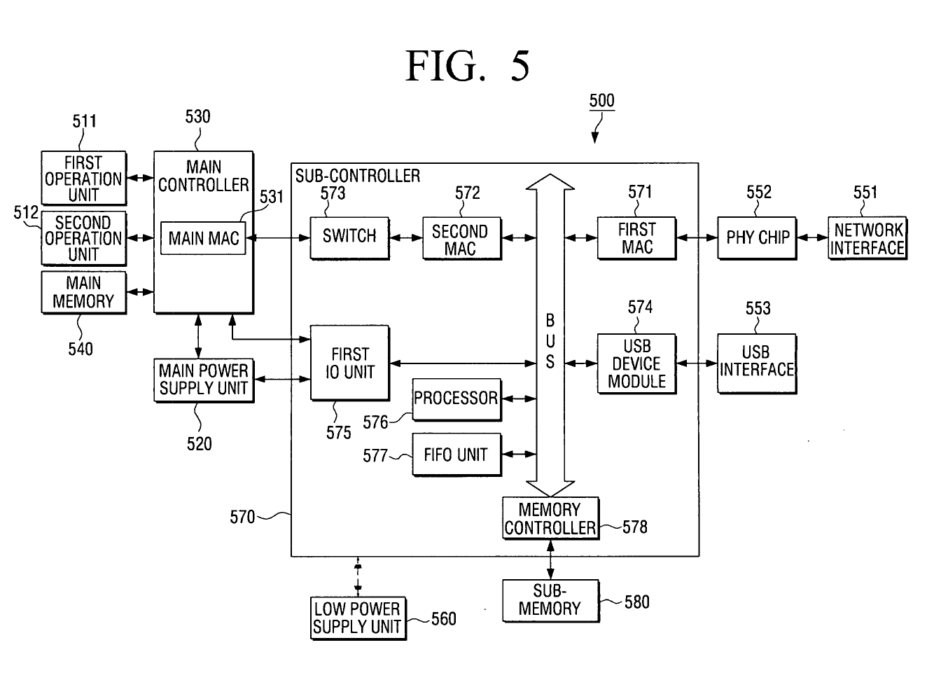

FIG. 5 is a block diagram illustrating an image forming apparatus according to another exemplary embodiment.

Referring to FIG. 5, an image forming apparatus 500 includes a first operation unit 511 and a second operation unit 512, a main power supply unit 520, a main controller 530, a main memory 540, a network interface 551, a PHY chip 552, a USB interface 553, a low power supply unit 560, a sub-controller 570, and a sub-memory 580. Since the respective components of the image forming apparatus 500 are almost the same as those of the image forming apparatus 300 of FIG. 3, the detailed description thereof is omitted. Also, for the sake of simplicity, the wakeup receiver 354, the fax transceiver 355, and the second and the third IO units 62, 63 are not illustrated.

However, in FIG. 5, the main controller 530 does not include a main USB device module 332 and the sub-controller 570 does not include a USB host module 50. Accordingly, the USB data received through the USB interface 553 is relayed to a main MAC 531 via a USB device module 574, a memory controller 578, the sub-memory 580, a second MAC 572, and a switch 573. The relaying process is controlled by the sub-controller 570 or a processor 576.

More specifically, in the standby mode, the USB data is temporarily stored to a FIFO unit 577 or temporarily stored to the sub-memory 580 via the USB device module 574 and the memory controller 578. If the USB data should be processed under the control of the main controller 530, the processor 576 converts the mode of the image forming apparatus 500 from the standby mode into the active mode. If the mode is converted from the standby mode into the active mode, the second MAC 572 reads out the temporarily stored USB data and relays the USB data to the switch 573, and the switch 573 relays the USB data to a main MAC 531 at the main controller 530 according to a transmitting time.

The network data received through the network interface 551 is relayed in the same manner as that described with reference to FIG. 3. For example, the network data is relayed through the PHY chip 552 and a first MAC 571.

In addition, a first IO unit 575 is connected to the main power supply unit 520 to receive power and is also connected to the main controller 530 to receive various signals or data.

FIG. 6 is a block diagram illustrating an image forming apparatus to control low power according to another exemplary embodiment.

Referring to FIG. 6, an image forming apparatus 600 includes two PHY chips 390, 395 instead of the switch 30 of the sub-controller 370 of FIG. 3. The two PHY chips 390, 395 relay data of an MII, a GMII or an RGMII format from a second MAC 20 to a main MAC 331 while synchronizing the data. The two PHY chips 390, 395 may be also interposed between the main controller 530 and the sub-controller 570 in the case of FIG. 5. In this case, the switch 573 is not provided. Other reference numbers were explained with reference to FIG. 3, for example.

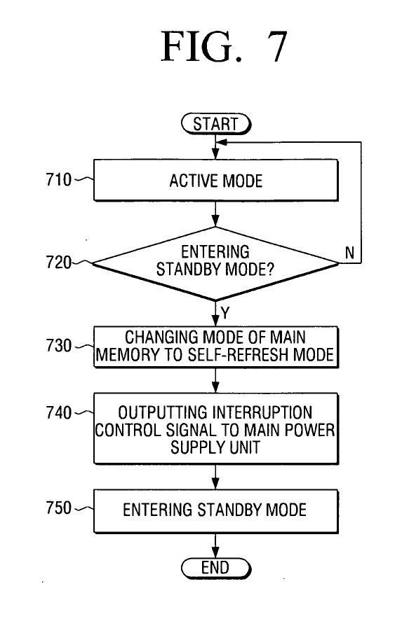

FIG. 7 is a flowchart illustrating a process of converting an active mode into a standby mode in a method of controlling low power of the image forming apparatus of FIG. 3.

Referring to FIG. 7, in the active mode in which the image forming apparatus 300 is normally operated (710), if it is determined that it is necessary to enter the standby mode (720), the main controller 330 changes the mode of the main memory 340 to a self-refresh mode and notifies the sub-controller 370 that the mode of the main memory 340 has been changed to the self-refresh mode (730).

According to the notification in 730, the sub-controller 370 determines that the main controller 330 is ready to enter the standby mode and outputs an interruption control signal to the main power supply unit 320 (740).

The main power supply unit 320 interrupts the power supplied to the main controller 330 and the plurality of operation units 311, 312 according to the interruption control signal such that the image forming enters the standby mode (750). Accordingly, power is supplied to the sub-controller 370 and the components 351-355, 380 connected to the sub-controller 370 so that the image forming apparatus 300 can consume minimum power in the standby mode.

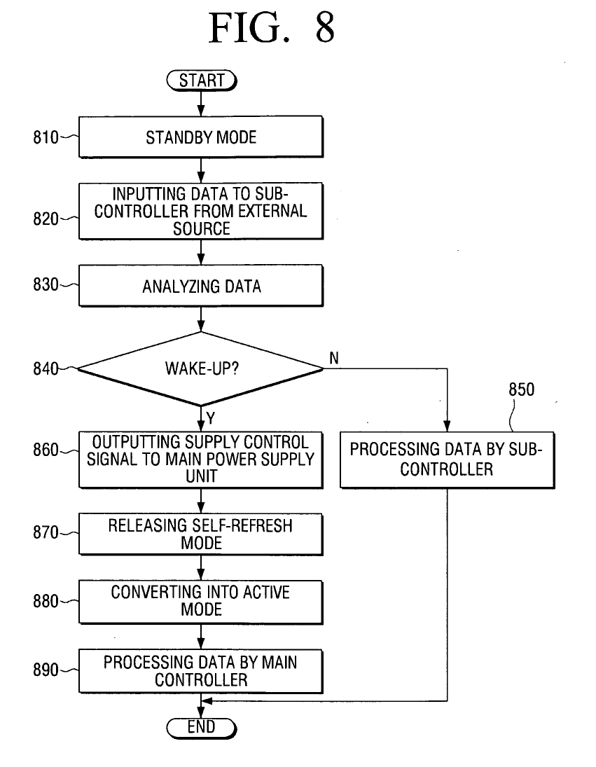

FIG. 8 is a flowchart illustrating a process of converting a standby mode into an active mode in the method of controlling low power of the image forming apparatus of FIG. 3.

Referring to FIG. 8, the image forming apparatus 300 is in the standby mode to save power (810). If data is input from an external source (820), the sub-controller 370 analyzes the data to determine whether to convert the standby mode into an active mode (830). The data input in operation 820 may be input through the network interface 351, the USB interface 353, the wakeup receiver 354, or the fax transceiver 355.

In operation 830, the sub-controller 370 temporarily stores the input data to the FIFO unit 80 or the sub-memory 380 and determines whether the input data is a signal satisfying the wakeup condition (840). That is, the sub-controller 370 determines whether the input data can be processed by the sub-controller 370 or the main controller 330.

If the data can be processed by the sub-controller 370, the sub-controller 370 maintains the standby mode and processes the data using information stored in the sub-memory 380 (850). For example, if the input data inquires about the status of the image forming apparatus 300, the processor 70 searches for the corresponding status information from the sub-memory 380 and responds to the inquiry.

On the other hand, if the wakeup condition is satisfied in operation 840, the sub-controller 370 outputs a supply control signal to the main power supply unit 320 (860).

The main power supply unit 320 releases the self-refresh mode of the main memory 340 according to the supply control signal (870), and supplies power to the main controller 330 and the components 311, 312, 340 connected to the main controller 330 to convert the mode from the standby mode into the active mode (880).

If the mode is converted from the standby mode into the active mode, the sub-controller 370 relays the data temporary stored to the FIFO unit 80 or the sub-memory 380 to the main controller 330 and the main controller 330 controls a corresponding operation unit to process the relayed data (890).

Since the relaying process in operation 890 was described with reference to FIG. 3, the relaying of the network data, the relaying of the USB data, the relaying of the data input from the wakeup receiver 354, and the relaying of the fax data are not described.

The process of FIG. 8 can be applied to the image forming apparatuses 400, 500, 600 shown in FIGS. 4 to 6.

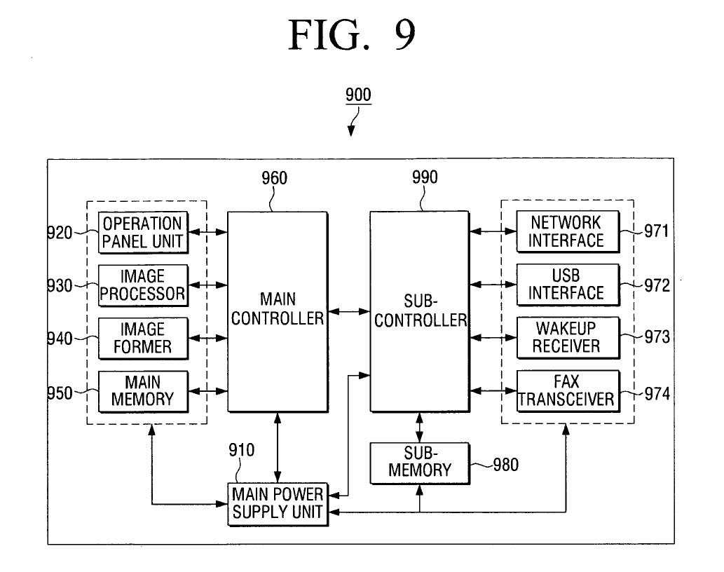

FIG. 9 is a block diagram illustrating an image forming apparatus to control low power according to another exemplary embodiment.

Referring to FIG. 9, an image forming apparatus 900 includes a main power supply unit 910, an operation panel unit 920, an image processor 930, an image former 940, a main memory 950, a main controller 960, a network interface 971, a USB interface 972, a wakeup receiver 973, a fax transceiver 974, a sub-memory 980, and a sub-controller 990.

Since the operations of the main power supply unit 910, the main memory 950, the main controller 960, the network interface 971, the USB interface 972, the wakeup receiver 973, the fax transceiver 974, the sub-memory 980, and the sub-controller 990 are almost the same as those of the components described with reference to FIGS. 3 to 6, detailed description thereof is omitted.

The operation panel unit 920 includes, as a user interface, a plurality of function keys and a touch screen, for example, to receive a user command from a user, and also includes a display panel to display the status of the image forming apparatus 900. However, the operation panel unit 920 is not limited thereto and may include any of a plurality of input options.

The image processor 930 processes printing data, scanning data, or fax data in the formats suitable for their respective functions. For example, the image processor 930 converts the printing data into bitmap data using a corresponding emulator. The printing data is input to a personal computer connected via the USB interface 972 and the fax data may be input via the fax transceiver 974.

The image former 940 forms an image based on the data processed by the image processor 930. For example, if the image former 940 includes a scanner (not shown) or a printing engine unit (not shown), the image former 940 scans, prints, and copies the data.

The main memory 950 stores various programs necessary to realize the functions of the image forming apparatus 900, various data generated during the operation of the image forming apparatus 900, and status information of the image forming apparatus 900, and may be a ROM or a RAM.

The main controller 960 controls the overall operation of the image forming apparatus 900 according to a stored control program. For example, if a ring signal is received through the fax transceiver 974 and the mode is converted from the standby mode into the active mode under the control of the sub-controller 990, the main controller 960 controls the image former 940 to scan and print the fax data relayed through the fax transceiver 974 and the sub-controller 990.

According to exemplary embodiments described above, in the standby mode, the power supplied to the main controller 130, 330, 430, 530, 960 is completely interrupted and the power supplied to the sub-controller 140, 370, 470, 570, 990 is maintained so that power consumption can be minimized. Also, by allowing data input from an external source to communicate with the sub-controller 140, 370, 470, 570, 990, the data input in the standby mode can be effectively processed. That is, if the input data can be processed by the sub-controller 140, 370, 470, 570, 990, the sub-controller 140, 370, 470, 570, 990 processes the data by itself while maintaining the standby mode, and if the data can be processed by the main controller 130, 330, 430, 530, 960, the mode is converted from the standby mode into the active mode. Therefore, the mode is selectively converted from the standby mode into the active mode so that the power consumption can be minimized.

Although a few embodiments have been shown and described, it would be appreciated by those skilled in the art that changes may be made in this embodiment without departing from the principles and spirit of the invention, the scope of which is defined in the claims and their equivalents.

1-30. (canceled)

31. An image forming apparatus, comprising:
an operation unit to perform a printing operation;
a communication interface to receive data from an external source;
a main memory to store a program for driving the operation unit;
a main controller coupled to the main memory to control the operation unit by executing the program accessed from the main memory in an active mode;
a main power supply unit supplying power to the main memory and the main controller; and
a sub-controller coupled between the communication interface and the main controller,
wherein, when the operation unit is in an idle state for a predetermined time during the active mode, the main controller transitions from the active mode to a standby mode,
wherein the main memory operates in a self-refresh mode during the standby mode,
wherein, during the standby mode, the sub-controller receives data via the communication interface, determines whether the received data is to be processed by the sub-controller or the main controller and wakes up the main controller if it is determined that the received data is to be processed by the main controller.

32. The image forming apparatus according to claim 31, wherein the sub-controller comprises:
a first media access controller (MAC) receiving data input through the communication interface;
a second MAC outputting data received by the first MAC; and
a switch controlling a transmitting time of the output data.

33. The image forming apparatus according to claim 32, wherein the output data is in at least one format of media independent interface (MII), gigabit MII (GMI), and reduced GMII (RGMII),
wherein the switch controls the transmitting time of the output data so as to transmit the data in the at least one format of the MII, the GMII, and the RGMII.

34. The image forming apparatus according to claim 31, further comprising:
a universal serial bus (USB) device module receiving data through a universal serial bus (USB) interface; and
a USB host module transmitting the data received by the USB device module to the main controller.

35. The image forming apparatus according to claim 32, wherein the sub-controller further comprises:
a processor controlling the main power supply unit to supply the power to the main controller when the data received through the first MAC in the standby mode is data that is processable by the main controller,
wherein the second MAC transmits the received data to the switch when the main controller is converted into the active mode.

36. The image forming apparatus according to claim 34, wherein the main controller is converted into the active mode when the data received through the USB device module in the standby mode is data that is to be processed by the main controller,
wherein the USB host module transmits the data received through the USB device module to the main controller when the main controller is converted into the active mode.

37. The image forming apparatus according to claim 31, wherein the sub-controller comprises:
a first MAC receiving data through the communication interface;
a processor controlling the main power supply unit to re-supply the power to the main controller when the data received through the first MAC is data that is processable by the main controller; and
a USB host module transmitting the data received through the first MAC to the main controller when the main controller is converted into the active mode by the re-supplied power.

38. The image forming apparatus according to claim 37, further comprising a USB device module receiving data through a universal serial bus (USB) interface,
wherein the main controller is converted into the active mode when the data received through the USB device module is data that is to be processed by the main controller,
wherein the USB host module transmits the data received through the USB device module to the main controller.

39. The image forming apparatus according to claim 31, further comprising:
a USB device module receiving data through a universal serial bus (USB) interface;
wherein the main controller is converted into the active mode when the received data is data that is to be processed by the main controller; and
a second MAC transmitting the data received through the USB device module to the main controller when the main controller is converted into the active mode.

40. The image forming apparatus according to claim 39, wherein the sub controller further comprises a first MAC receiving data through the communication interface,
wherein the main controller is converted into the active mode if the receive data is data that is to be processed by the main controller, and the second MAC transmits the data received through the first MAC to the main controller when the main controller is converted into the active mode.

41. The image forming apparatus according to claim 31, wherein the main memory comprises a DDR memory.

42. The image forming apparatus according to claim 31, further comprising a low power supply unit supplying power to the sub-controller.

43. The image forming apparatus according to claim 31, wherein the communication interface comprises a network interface and a PHY chip is coupled between the network interface and the sub-controller.

44. The image forming apparatus according to claim 31, wherein further comprising:
a fax transceiver to transceive data with an external facsimile machine; and
a wakeup button to request conversion into the active mode, and
wherein data input via the fax transceiver or the wakeup button is analyzed to determine whether to convert into the active mode.

45. The image forming apparatus according to claim 44, wherein the main controller is converted into the active mode and the fax transceiver transmits fax data received from the external facsimile machine to the main controller when a ring signal is detected from the fax transceiver.

46. A method of controlling power consumed by an image forming apparatus which comprises a communication interface, a main controller, and a sub-controller coupled between the main controller and the communication interface, the method comprising:
controlling an operation of a printing unit of the image forming apparatus by executing a program accessed from a main memory in an active mode, by the main controller;
when the printing unit of the image forming apparatus is in an idle state for a predetermined time in the active mode, transitioning the main controller from the active mode to a standby mode and operating the main memory in a self-refresh mode;
when data is received through the communication interface in the standby mode, determining whether the received data is to processed by the sub-controller or the main controller; and waking up the main controller into the active mode if it is determined that the received data is to be processed by the main controller.

47. The method according to claim 46, further comprising:
receiving data input from the communication interface, by a first MAC;
outputting the data received by the first MAC, by a second MAC; and
controlling a transmitting time of the output data.

48. The method according to claim 47, wherein the outputting comprises outputting the received data in at least one format of MII, GMII, and RGMII,
wherein the controlling the transmitting time comprises controlling the transmitting time of the output data so as to transmit the data in the at least one format of the MII, the GMII, and the RGMII.

49. The method according to claim 46, further comprising:
receiving data input through a (USB) interface, by a USB device module; and
transmitting the data received through the USB device module to the main controller, by a USB host module.

50. The method according to claim 47, further comprising:
converting the main controller into the active mode, when the data received through the first MAC in the standby mode is data that is to be processed by the main controller,
wherein the outputting comprises outputting the received data by the second MAC when the main controller is converted into the active mode.

51. The method according to claim 49, further comprising:
determining whether to convert into the active mode based on whether the data received through the USB device module in the standby mode is data that is to be processed by the main controller,
wherein the transmitting comprises transmitting the data received through the USB device module to the main controller when the main controller is converted into the active mode.

52. The method according to claim 46, further comprising:
receiving data input from the communication interface, by a first MAC;
converting into the active mode by supplying the power to the main controller, when the data received through the first MAC is data that is processable by the main controller; and
transmitting the data received through the first MAC to the main controller, by a USB host module.

53. The method according to claim 52, further comprising receiving data input via a universal serial bus (USB) interface, by a USB device module,
wherein the transmitting comprises transmitting the data received through the USB device module to the main controller, by the USB host module, when the main controller is converted into the active mode.

54. The method according to claim 46, further comprising:
receiving data input via a universal serial bus (USB) interface, by a USB device module;
converting the main controller into the active mode by supplying the power to the main controller, by the main power supply unit, when the data received through the first MAC is data that is to be processed by the main controller; and
transmitting the data received through the USB device module to the main controller, by a second MAC.

55. The method according to claim 54, further comprising receiving data input through the communication interface, by a first MAC,
wherein the transmitting comprises transmitting the data received by the first MAC to the main controller, by the second MAC, when the main controller is converted into the active mode.

56. The method according to claim 46, wherein the interrupting comprises:
converting the main memory communicating with the main controller into a self-refresh mode;
interrupting power supplied from the main power supply unit to the main controller under control of the sub-controller; and
maintaining power supplied to the sub-controller.

57. The method according to claim 46, wherein the communication interface comprises a network interface.

58. The method according to claim 46, wherein the determining comprises connecting to a fax transceiver to transceive data with an external facsimile machine or a wakeup button to request conversion into the active mode, and analyzing data input from the fax transceiver or the wakeup button to determine whether to convert into the active mode.

59. The image forming apparatus according to claim 31, wherein the received data to be processed by the main controller comprises printing data.

60. The image forming apparatus according to claim 31, wherein, during the standby mode, if it is determined that the received data is processable by the sub-controller, the received data is processed by the sub-controller without waking up the main controller from the standby mode.

61. The image forming apparatus according to claim 31, wherein, during the active mode, the sub-controller relays data received via the communication interface to the main controller.

62. The method according to claim 46, wherein the received data to be processed by the main controller comprises printing data.

63. The method according to claim 46, wherein, during the standby mode, if it is determined that the received data is processable by the sub-controller, the received data is processed by the sub-controller without waking up the main controller.

64. The method according to claim 46, wherein, during the active mode, the sub-controller relays data received via the communication interface to the main controller.
